(19) United States
(12) Patent Application Publication
(10) Pub. No.: US 2025/0061905 A1
(43) Pub. Date: Feb. 20, 2025

(54) METHOD FOR EMBEDDING OR DECODING AUDIO PAYLOAD IN AUDIO CONTENT

(71) Applicant: Mediatest Research GmbH, Vienna (AT)

(72) Inventor: Brar PAMINDER, Bucks (GB)

(21) Appl. No.: 18/934,962

(22) Filed: Nov. 1, 2024

Related U.S. Application Data
(63) Continuation of application No. PCT/AT2022/060151, filed on May 2, 2022.

(51) Int. Cl. G10L 19/025; G10L 25/45

(52) U.S. Cl. CPC G10L 19/025; G10L 25/45

(57) ABSTRACT

A method for embedding audio payload in audio content, a method for decoding audio payload embedded in audio content, and a method for detecting transients. Complementary spreading sequences are used in direct spread spectrum watermarking or alternatively using multi-level spreading sequences applied to modulate the amplitude spectrum of the audio content to embed the payload by spreading the payload bits. Decoding watermark bits based on correlation sign or decoding by obtaining a number of windows used during encoding to combine the amplitude spectra into one window for calculating the correlation with at least spreading sequence. Encoding and decoding a payload by using multiple windows combined with different polarities as a block to transport the same payload.

The present application is a continuation of International Application PCT/AT2022/060151 filed on May 2, 2022. Thus, all of the subject matter of International Application PCT/AT2022/060151 is incorporated herein by reference.

### BACKGROUND OF THE INVENTION

In one aspect the invention is in the field of encoding at least one audio payload in audio content. In another aspect the invention relates to decoding at least one audio payload from audio content. In yet another aspect the invention relates to detection of transients in audio content.

The need for embedding audio payload (e.g., a watermark) in audio content such that the audio payload is not perceived by a listener, but the audio payload is robust against intentional manipulations or disturbances is well established in the art (see by way of example EP 2 362 387 A1).

It is also known to use spread spectrum techniques for watermarking as described, e.g., in Malvar et al., “An improved spread spectrum technique for robust watermarking”, (DOI: 10.1109/ICASSP.2002.1004617) and Ullah et al., “Improving the security level in direct sequence spread spectrum using dual codes”, International Journal of Security and Its Applications, Vol. 6 No. 2, April 2012.

Known techniques do not create audio payload embedded in audio content which is robust when broadcasting through the airspace. With respect to decoding, pre-synchronization between sender and receiver is necessary.

Although redundant coding techniques are known in the art primarily for digital data transmission methods there is still need for improvement as known techniques are adapted to correct burst bit errors and are poorly suited for encoding audio payload in audio content.

### SUMMARY OF THE INVENTION

It is an object of the invention to provide a method of encoding at least one audio payload in audio content in a way which is robust when broadcasting through the airspace.

It is another object of the invention to provide a method of decoding at least one audio payload from audio content, in particular without the need to perform pre-synchronization (this means that detection can start at any time mark of the audio content).

It is another object of the invention to provide a method for detecting transients in audio content.

Yet another object of the disclosure relates to a computer program which, when the program is executed by a computer, causes the computer to carry out any of the methods described in this disclosure.

Still another object of the disclosure relates to a data carrier signal carrying such a computer program or carrying audio content into which at least one audio payload has been embedded according to any of the methods described in this disclosure.

Yet another object of the disclosure relates to an encoder, a decoder and a transient detector being configured, respectively, to encode or decode at least one audio payload in audio content according to a method as described in this disclosure or to detect transients in audio content.

Still other objects and advantages of the invention will in part be obvious and will in part be apparent from the specification and drawings.

In this disclosure the term “binary sequence” is understood to refer to a sequence of bits wherein each bit has a first value or a second value. Usually, the first value is denoted as “1” or “0” and the second value is denoted as “0” or “1”, however, other representations are possible.

Audio content is sound in a digital format.

One object of the disclosure relates to a method for encoding at least one audio payload in audio content, comprising at least the steps of:
providing audio content into which at least one audio payload is to be embedded in the form of an amplitude spectrum in the frequency domain
providing at least one audio payload in the form of a binary sequence wherein each bit of the binary sequence has a first value or a second value
applying at least one spreading sequence to the binary sequence (which represents the at least one audio payload) to obtain at least one spreading binary sequence, such that
   if a bit of the binary sequence is of the first value, the bit is spread by the at least one spreading sequence, and
   if a bit of the binary sequence is of the second value, the bit is spread by the negative of the at least one spreading sequence
using the at least one spreading binary sequence to modulate the amplitude spectrum of the audio content in the frequency domain to embed the at least one audio payload into the audio content

Of course, the audio content can be transformed back into the time domain using the inverse transform that was used to obtain the amplitude spectrum in the frequency domain.

During decoding of an audio payload which has been encoded by this method, it is possible to determine the bits of the audio payload simply by calculating at least one correlation coefficient between:
at least part of the amplitude spectrum of the audio content, and
the at least one spreading binary sequence, or its negative It is determined in dependence on the sign of the correlation coefficient whether an embedded bit of the at least one audio payload is of the first value or the second value thereby obtaining the value of the embedded bit of the embedded audio payload.

### Simple Numerical Example 1

Audio payload in the form of a one-bit binary sequence is to be embedded into audio content with the random spreading sequence [0 1 0 0] or, if zeros are replaced with −1, with the spreading sequence SS_ONE=[−1+1−1−1]. If the payload were bit 0, the same spreading sequence would be used but with reversed signs SS_ZERO=[+1−1+1+1]. Audio payload of more than one bit can be treated analogously for each bit.

The audio content (in this example called “SIGNAL”) is in the form of an amplitude spectrum in the frequency domain, by way of example in the following audio content with only four frequency bins is used: SIGNAL=[2 2 4 1]. The different positions in the vector signify the different frequency bins, while the numbers signify the amplitude of the signal in each frequency bin.

Using the spreading binary sequence SS_ONE to modulate the amplitude spectrum of the audio content SIGNAL in the frequency domain to embed the at least one audio payload (i.e., in this example the single bit “1” spread into SS_ONE) into the audio content, one obtains audio content in the frequency domain with embedded audio payload SIGNAL_WM:

$$SIGNAL\_WM = SIGNAL + SS\_ONE , i . e . , SIGNAL\_WM = [ \begin{matrix}1 & 3 & 3 & 0\end{matrix} ]$$

The SIGNAL_WM can be transformed back into the time domain to obtain audio content with embedded audio signal that can be directly listened to.

Another object of the disclosure relates to a method for encoding at least one audio payload in audio content, comprising at least the steps of:
obtaining audio content into which at least one audio payload is to be embedded in the form of an amplitude spectrum
providing at least one audio payload in the form of a binary sequence
applying a first spreading sequence to the binary sequence (which represents the at least one audio payload) to obtain a first level spreading binary sequence
applying at least one more spreading sequence (which is, of course, different from the first spreading sequence and can have equal length or different length) to the first level spreading binary sequence to obtain at least one more spreading binary sequence of a higher level
using the at least one more spreading binary sequence of a higher level to modulate the amplitude spectrum of the audio content to embed the at least one audio payload into the audio content

It was found that multiple expansion of audio payload with shorter spreading sequences is more efficient than expansion by use of one long spreading sequence. That is, if the length of the audio payload is N, and the length of the first spreading sequence is L₁ (at the lowest level), then the length of the first spreading sequence will be equal to N·L₁. The resulting sequence (with length N·L₁) can be extended at a second, higher, level in a similar way with a new spreading sequence of length L₂. Thus, a new sequence of length N·L₁·L₂ will be obtained. Continuing this process m times, finishing with a highest-level spreading sequence of length Lₘ, a sequence of length N·L₁·L₂· . . . · Lₘ will be obtained.

### Simple Numerical Example 2

Audio payload WM consists of three bits such that WM=[1 0 1]. For value “1” the first level spreading sequence [1-1] is used, for value “0” the first level spreading sequence [−1 1] is used such that a first level spreading binary sequence equal to [1−1−1 1 1−1] is obtained.

In a next step, for value “1” the second level spreading sequence [1−1 1] is used, for value “−1” the second level spreading sequence [−1 1−1] is used such that a spreading sequence of higher (and, in this example, highest) level equal to [1 −1 1 −1 1 −1−1 1−1 1−1 1 1−1 1−1 1−1] is obtained.

This highest spreading sequence is used to modulate the amplitude spectrum of the audio content in the frequency range (in this example, with respect to eighteen frequency bins), e.g., by increasing (i.e. multiplying, in the simplest case, addition can be used as in example 1) the amplitude of a frequency bin, if the corresponding value of the highest-level spreading sequence is “1” and decreasing (i.e., dividing) the amplitude of a frequency bin, if the corresponding value of the highest-level spreading sequence is “−1”.

In practice, two or three levels of spreading sequences are usually enough.

Of course, the first variant and the second variant of a method for encoding at least one audio payload in audio content can be combined, as shown in the following numerical example.

### Simple Numerical Example 3

Two more spreading sequences of a higher level (level 2) are given, one for value “1” and one for value “0”:

$$SS\_ONE \_ 2 = [ \begin{matrix}+ 1 & - 1 & + 1\end{matrix} ] \\ SS\_ZERO \_ 2 = [ \begin{matrix}- 1 & + 1 & - 1\end{matrix} ]$$

Bit 1, at level 1, is spread to [−1+1−1−1], and, at level 2, is spread to [−1+1−1+1−1+1−1+1−1−1+1−1] which can be hidden in twelve bins of frequency (called in short B₁ . . . . B₁₂).

Both variants for a method for encoding are based on a spread spectrum technique in frequency space. At least one spreading sequence is used for spreading the binary sequence representing the at least one audio payload. In the second method, at least two spreading sequences are used instead of one long spreading sequence.

Some of the advantages of both variants for a method for encoding are the possibility of dealing with large binary data sequences, the generation of audio content provided with embedded payload which can be decoded after having been sent over air and resistance to noise interference and compression techniques. Both variants for a method for encoding can be used for live encoding.

Both variants for a method for encoding use a redundancy coding technique that is adapted to the numerous interference that occurs when audio signals representing audio content are transmitted through airspace and compression.

Both variants for a method for encoding are scalable due to the ability to use different frequency ranges, changing the number of levels and lengths of the spreading sequences. Due to this, it is possible to achieve the necessary compromise between payload size and recognition quality.

Both variants for a method for encoding allow for large payload size and short detection time.

Both variants for a method for encoding can be used directly to protect original audio content from copying and to facilitate market research. Moreover, this technique allows to add metadata to audio content and synchronize devices through the acoustic channel.

It should be noted that the audio payload can be in any form such as a watermark, metadata, or the like. A watermark is understood to be a unique electronic identifier to be embedded in audio content.

It should further be noted that, although both variants for a method for encoding described herein are particularly suited for audio content that is sent through air, they are not limited to this transmission channel. Payload recognition can also be performed by directly reading a file.

Embedding of audio payload occurs in the frequency domain of the audio content. This provides secrecy, as well as reliability against interference and reverberation when transmitted through an acoustic data channel.

Embedding audio payload (in the following sometimes called exemplary “watermarking”) means changing the spectrum of the audio content. The spectrum changes are preferably carried out using a short-time window method. The advantages of this technique are predictable computational complexity, as well as the presence of a DSP block in FPGA systems, which allows developing highly efficient hardware solutions.

The source information of the audio payload for encoding must be represented in binary form.

Preferably, a fast Fourier transform (FFT) and its inverse (IFFT), are used to transform signals between the time domain and the frequency domain.

Another object of the disclosure relates to a method for decoding at least one audio payload from audio content, comprising at least the steps of:
providing audio content into which at least one audio payload was embedded in the form of an amplitude spectrum in the frequency domain
obtaining the at least one spreading binary sequence that was used to modulate the amplitude spectrum of the audio content in the frequency domain for embedding the at least one audio payload into the audio content
calculating at least one correlation coefficient between
   at least part of the amplitude spectrum of the audio content, and
   the at least one spreading binary sequence, or its negative, and in dependence on the sign of the at least one correlation coefficient determining whether an embedded bit of the at least one audio payload is of the first value or the second value thereby obtaining the value of the embedded bit of the embedded audio payload

By way of example, the at least one spreading binary sequence could be obtained starting from a seed or key value by using a common random number generator or pseudo-random number generator.

### Simple Numerical Example 4

Getting back to numerical example 1, it is possible to calculate a correlation coefficient (e.g., Pearson correlation) with both spreading sequences:

$$cor ( SS\_ONE , SIGNAL\_WM ) = 0.56 > 0 , \\ therefore value “ 1 ” is embedded \\ cor ( SS\_ZERO , SIGNAL\_WM ) = - 0.56 < 0 , \\ therefore value “ 0 ” is embedded$$

The point is that it is not necessary to use two separate spreading sequences, one for “0” and one for “1”. It is sufficient to check only for the first one (or only for the second one), and by the sign of the correlation it can be immediately understood which bit will insert a “1” or “0”.

In this numerical example, the level of p-value is at 44.4%, which is a lot. To accept the hypothesis that there is not a random correlation, but a correlation caused by the presence of a watermark, the p-value should be less than a given number, e.g., 5%.

In case, two levels of spreading sequences are used, it is possible to calculate correlation coefficients at each level until one obtains a number the sign of which can be determined at the lowest level, e.g., as shown in the following simple numerical example 5 which uses the results of numerical example 3.

### Simple Numerical Example 5

### First Step at Level 2:

$$cor ( [ {B}_{1} , {B}_{2} , {B}_{3} ] , ss\_one \_ 2 ) = {F}_{1} \\ cor ( [ {B}_{4} , {B}_{5} , {B}_{6} ] , ss\_one \_ 2 ) = {F}_{2} \\ cor ( [ {B}_{7} , {B}_{8} , {B}_{9} ] , ss\_one \_ 2 ) = {F}_{3} \\ cor ( [ {B}_{10} , {B}_{11} , {B}_{12} ] , ss\_one \_ 2 ) = {F}_{4}$$

### Second Step at Level 1:

$$cor ( [ {F}_{1} , {F}_{2} , {F}_{3} , {F}_{4} ] , ss\_one \_ 1 ) > 0 thefore final\_bit = 1 \\ cor ( [ {F}_{1} , {F}_{2} , {F}_{3} , {F}_{4} ] , ss\_one \_ 1 ) < 0 thefore final\_bit = 0$$

### Second Variant for a Method for Decoding Audio Payload:

Yet another object of the disclosure relates to a method for decoding at least one audio payload from audio content, comprising at least the steps of:
obtaining the at least one more spreading binary sequence that was used to modulate the amplitude spectrum of the audio content for embedding the at least one audio payload into the audio content
obtaining information about the number of windows used during encoding of the at least one audio payload (window is a slice of data points in the time domain, the length of which corresponds to the applied window function)
using a decoder window to read a block of the audio content into which the at least one audio payload has been embedded
dividing the block in the decoder window into a number of windows which is greater than the number of windows used during encoding of the at least one audio payload
calculating for each window its amplitude spectrum
combining the obtained amplitude spectra into one window
calculating at least one correlation between the at least one more spreading binary sequence and the combined amplitude spectra thereby obtaining the embedded audio payload

Both variants allow for blind detection of audio payload without the need for performing pre-synchronization.

Another object of the disclosure relates to a method for detecting transients comprising checking each window of an audio content, in particular an incoming audio stream, before applying a method to encode an audio payload as described above, wherein each window is split into fragments and a transient is discovered by discovering a change in a pre-determined property of the audio content between adjacent fragments.

In the frequency domain, to preserve sound quality, encoding audio payload with a strength depending on the frequency range can be used. It is possible to use an absolute hearing threshold curve as described in ISO 226 to determine allowable strength of the audio payload depending on the frequency range.

The source information for the audio payload must be represented in the form of a binary sequence (i.e., a sequence of 0 and 1 or −1 and 1 or any other representation having two different symbols for encoding two different values, in the following the symbols 0 and 1 or −1 and 1 will be used without any intended restriction) for encoding. This binary sequence represents the audio payload. Direct sequence spread spectrum technique implies that each bit of the audio payload is assigned a spreading sequence to obtain a spreading binary sequence by replacing each bit of the audio payload with the corresponding spreading sequence.

In some embodiments at least one spreading sequence, preferably several or all of the spreading sequences, is a pseudo-random sequence (pn-sequence). By way of example, Barker sequences can be used.

After replacing each bit of the audio payload with the corresponding spreading sequence, the spreading binary sequence is obtained, in which the audio payload is encrypted. The spreading binary sequence is used to modulate the amplitude spectrum of the original audio content. Thus, the audio payload is hidden in the audio content.

In a preferred embodiment of the encoding method the step of applying at least one more spreading sequence different from the first spreading sequence to the first spreading binary sequence to obtain at least one more spreading binary sequence of a higher level includes at least:
providing a number of different spreading sequences
applying a spreading sequence chosen from the number of spreading sequences to obtain a second level spreading binary sequence
choosing a further spreading sequence from the number of spreading sequences and applying the further spreading sequence to obtain a third level spreading binary sequence
repeating the previous step for a number of times, the number of times being equal to or larger than zero, until a highest-level spreading binary sequence is obtained
   and wherein the step of using the at least one more spreading binary sequence to modulate an amplitude spectrum of the audio content to embed the at least one audio payload into the audio content includes at least using the highest-level spreading binary sequence to modulate the amplitude spectrum of the audio content in the frequency domain to embed the at least one audio payload into the audio content.

In other words, although it is sufficient for the invention to use as little as one spreading sequence, the use of at least two different spreading sequences is preferred for spreading. In the prior art, one long spreading sequence is used.

In some embodiments, the step of using the at least one spreading binary sequence to modulate an amplitude spectrum of the audio content to embed the at least one audio payload into the audio content includes at least:
in case a bit of the at least one binary sequence is of a first value increasing the amplitude corresponding to the bit of the at least one more binary sequence
in case a bit of the at least one binary sequence is of a second value reducing the amplitude corresponding to the bit of the at least one more binary sequence

Preferably, a given number of the largest amplitudes of the amplitude spectrum of the audio signal is not modulated to avoid formation of beats.

One aspect of the present invention is the use (preferably at each stage) for expanding the original bit sequence of only two sequences wherein, with respect to at least two different levels of spreading, preferably with respect to every level, the step of applying at least one spreading sequence of that level to the binary sequence of the previous level to obtain at least one spreading binary sequence of a higher level, is done such that:
if a bit of the binary sequence of the previous level is of the first value, the bit is spread by the spreading sequence, and
if a bit of the binary sequence of the previous level is of the second value, the bit is spread by the negative of the spreading sequence

For example, the first spreading sequence corresponds to a bit with value “1”, the second spreading sequence to the opposite value “0”. The spreading sequences are obtained from one another by changing the values of the bits to the opposite. Thus, in the detection it is necessary to use (at each level) only (without loss of generality) the first or the second spreading sequence. The value of the audio payload bit (at each step) will be hidden in the correlation sign. The correlation module to some extent determines the probability of a type 1 error in a bit at the current level.

Combining this technique with the use of several spreading sequences at different levels instead of a single spreading sequence (so that there is only a single level), in some embodiments, it is provided that the step of applying at least one more spreading sequence different from the first spreading sequence to the first level spreading binary sequence to obtain at least one more spreading binary sequence of a higher level includes at least:
providing a number of different spreading sequences
applying a spreading sequence chosen from the number of spreading sequences to obtain a second level spreading binary sequence
choosing a further spreading sequence from the number of spreading sequences and applying the further spreading sequence to obtain a third level spreading binary sequence
repeating the previous step for a number of times, the number of times being equal to or larger than zero, until a highest-level spreading binary sequence is obtained
   and wherein the step of using the at least one more spreading binary sequence to modulate an amplitude spectrum of the audio content to embed the at least one audio payload into the audio content includes at least using the highest-level spreading binary sequence to modulate the amplitude spectrum of the audio content in the frequency domain to embed the at least one audio payload into the audio content

The audio content into which the audio payload is to be embedded can be broken down into windows which do or do not overlap, and the method can be applied to each window. A window is a fragment of audio content whose length matches the size of a window function.

In other words, in some embodiments, it is provided that the amplitude spectrum is fragmented into audio signal windows by applying a windowing transform into the frequency domain to the amplitude spectrum, wherein it is preferably provided that audio signal windows containing transients are encoded with less payload strength or are skipped.

In some embodiments overlapping windows are used. The step of overlapping windows not only avoids artifacts that occur at the junctions of windows, but also changes the spectrum of audio content continuously throughout its length. This makes blind detection of audio payloads without prior synchronization easier.

Several consecutive windows are combined into blocks, such that windows in one block contain the same binary sequence wherein, preferably, each window in a block is assigned a polarity and spectra of windows of one block are added in accordance with their polarity value.

After modulating the spectrum of a current window and returning to the time domain, the formation of various audible artifacts is possible. The greatest danger is represented by windows in which there are transient processes. They contribute to the formation of pre-echoes in the watermarked audio signal. Therefore, the use of a transient detector is preferred as described below.

A preliminary synchronization can be done when the detector window starts its movement from the same position from which the window was taken to introduce the watermark in the encoder. That is, if discrete samples are numbered as “1 2 3 4 5 6 7 8 9 . . . ” and a window size of four samples is used, then window 4 then the encoder produced the following breakdown (with overlap): (1234) (3456) (5678) . . . . If the detector window accepts (2345) this is recognition without prior synchronization. If the decoder does run a synchronization algorithm first and selects (1234) this is pre-synchronized. Synchronization is an additional cost of computing resources. Therefore, it should be abandoned.

If the detector moves along the track of the audio content with a smaller step than the window size, the detector receives windows: (1234) (2345) (3456) . . . . These windows are aggregated, and their analysis gives a mixture of good and bad windows. But bad windows do not give wrong watermarks, they just give less correlation, and their joint analysis smooths out errors.

It is preferred to use a strong overlap (e.g., 50%), so the spectrum of the entire track changes evenly and there is no difference from which position to start recognition.

In some embodiments, the amplitude spectrum of the audio content is the result of a short-term Fourier transform, preferably with about 50% overlap.

In these embodiments, it is preferred to choose a length L_{FFT} of the amplitude spectrum such that 0.5·L_{FFT}+1≥N·L₁·L₂· . . . · Lₘ, N being the size of the binary sequence and L₁, L₂, . . . Lₘ being the sizes of the applied spreading sequences, wherein it is preferably provided that in case a size N·Π^{m} Lᵢ of a spreading sequence is less than 0.5·L_{FFT}+1 these frequency bins will be ignored during watermarking and during detection.

In some embodiments, the step of using the at least one more spreading binary sequence to modulate an amplitude spectrum of the audio content to embed the at least one audio payload into the audio content includes at least:
in case an element of the at least one more binary sequence is of a first type increasing the amplitude corresponding to the element of the at least one more binary sequence
in case an element of the at least one more binary sequence is of a second type reducing the amplitude corresponding to the element of the at least one more binary sequence

In these embodiments, it is preferred not to modulate a given number of the largest amplitudes of the amplitude spectrum of the audio signal to avoid formation of beats.

In some embodiments, it is preferred to combine several consecutive windows into blocks such that windows in one block contain the same binary sequence wherein, preferably, each window in a block is assigned a polarity and spectra of windows of one block are added in accordance with their polarity value. The polarity of a window is the value of the coefficient “+1” or “−1”, by which the spreading sequence is multiplied before modulation. Windows of one block are transformed into one window, in which the strength of the payload increases in proportion to the number of windows in the block. In other words, combining windows into one block is a duplication of the payload over time. Due to this, decoding can be performed successfully, even if several windows in the block were skipped by the decoder or were not initially encoded due to the triggering of a transient detector.

A “transient” is understood to be either a sudden change in the volume of an audio signal, such as a castanet or drum solo, or a sudden change in the dominant frequency of a signal, such as a guitar playing.

As described above, an audio signal can be broken into windows. To detect a window of an audio signal containing transients, a method for detecting transients (transient detector) can be used. The transient detector checks each window of the incoming audio stream before feeding it to the encoder.

To detect such windows, a transient detector can be used, which analyzes the spectrum of each window. As a result of the analysis, the detector informs the encoder about the presence of transients in the windows.

The transient detector may have different implementations:

In the simplest case, the incoming audio signal window is split into non-intersecting (sometimes overlapping) fragments. Then the energy of each fragment is calculated. Next, the change in energy from window to window is analyzed. Abrupt changes in the resulting energy change curve are characterized by a transient process. More complex implementations come down to constructing the envelope of an audio signal and its further analysis.

The preferred implementation of the transient detector is to split the original window into fragments and attempt to predict each subsequent fragment spectrum based on the previous spectrum. Sharp and unpredictable changes in the phase and amplitude spectrum indicate the presence of transient processes in the window.

Generally speaking, there are two preferred embodiments for decoding:
combining windows into one window (the polarity of windows is preferably chosen in accordance with the Barker sequences),
increasing frequency resolution by selecting a window in the detector with a multiple of the dimensions of the encoding window.

In some embodiments of the decoding method:
there are provided at least three different spreading sequences that have been used to modulate the amplitude spectrum of the audio content to embed the at least one audio payload into the audio content,
for each of the provided spreading sequences the correlation with the combined amplitude spectra is calculated,
the calculated correlations are combined into one new sequence,
iterating the process m times to obtain a sequence of length N.

In these embodiments it can be provided that before the step of calculating correlations, windows polarities are determined by all possible permutations in the spreading sequences that were used for encoding wherein it is preferably provided that the amplitude spectrum of the windows is cropped to an expanding sequence of length N·L₁·L₂· . . . · Lₘ.

Applying audio payload can degrade the quality of audio content. In particular, when encoding audio signals with a dominant frequency in the mid or high range of audible frequencies (where the watermark hides) such as ringing a bell, triangle, or solo on stringed instruments, audible reverberations can occur (or intensify). They are due to beats that result from the addition of two harmonics with similar frequencies and amplitudes.

For robust detection of payloads in an audio signal, several consecutive windows are combined into blocks. Windows in one block contain the same payload. Each window in the block is assigned a polarity. The polarity of a window is the value of the coefficient “+1” or “−1”, by which the spreading sequence is multiplied before modulation. Stability is achieved by adding the spectra of windows of one block in accordance with their polarity value. Thus, windows of one block are transformed into one window, in which the strength of the audio payload increases in proportion to the number of windows in the block. In other words, combining windows into one block is a duplication of the audio payload over time. Due to this, decoding can be performed successfully, even if several windows in the block were skipped by the decoder or were not initially encoded due to the triggering of the transient detector.

During the decoding process, the detector window reads a piece of audio content, the length of which is equal to the length of the block. The step of shifting the detector window is set to some value θ·L_{FFT} where L_{FFT} denotes FFT length and θ denotes part of the length. Thus, it is guaranteed that, earlier or later, the entire block will appear in the detector window with an accuracy of θ·L_{FFT}. It has been found that this is sufficient to successfully decode the audio payload. For greater reliability of detection, blocks are also sequentially duplicated. It was found that in the case when the detector window contains windows from blocks with different audio payloads, the decoding result depends on the ratio of windows. Thus, the lower bound for synchronization accuracy can be chosen to be half the block length.

It has been found that decoding is more likely to be successful if the decoder window boundaries coincide with the window boundaries. However, absolute timing accuracy is not required when using this method. Synchronization accurate to θ·L_{FFT} is sufficient for successful payload recognition.

Upon detection, the polarity of each window from the block is unknown. It is also unknown whether the analyzed windows belong to the same block. Therefore, a complete enumeration of all possible linear combinations of windows is carried out. In order to select from the set of all linear combinations the one with which the encoding was performed, the polarity of the windows in the block is determined in accordance with the Barker sequence. In this case, false combinations will have a minimum level in relation to the desired one.

It has been found that audio payloads are more stable when the spectra are subtracted, rather than when they are added. Therefore, out of two Barker sequences of the same length, to determine the polarity of windows in a block, it is better to choose the one that contains more negative values than positive ones. It is to be mentioned that initially in the encoder the polarities of the blocks can be selected in accordance with the Barker sequence (B1). The consequence of this is a complete enumeration of possible options in the decoder in accordance with the choice in encoder B1. If the length of B1 when encoding was equal to seven, then in the decoder one has to go through seven options.

The detector reads audio data at intervals several times shorter than the window length. The smaller the interval, the more detailed the track is examined—the more likely it is to detect audio payload, but the greater the computational load.

The decision whether the detected audio payload is true can be made up of the following two components: The first is the correlation value that was achieved when the audio payload was detected. The second is the number of repetitions of the audio payload, for a given period of time—the decay time. The audio payload can be stored in memory for no more than the decay time and then deleted.

With a small detector step, sequentially read windows are more likely to give the same audio payload, simply because they contain the same elements, and are very similar. In order to avoid an increase in weight by the second factor—the number of repetitions, it is necessary to count the number of repetitions for audio payloads found not one after another, but at a certain safe distance.

The standard scheme is when the polarity of the windows is as follows: {+−} {+−} . . . . That is, the sequence 10 or 01 is used to determine the polarity. It is the idea of this embodiment that, in fact, longer sequences produce a better effect. Moreover, it is best to choose Barker sequences for this purpose and where there are more zeros, that is, subtractions. For example, from {++} and {−+}, the second one is preferable.

Incorrectly decoded audio payloads can be detected if the correlation values are below a certain threshold. The correlation threshold is chosen from a compromise between decoding accuracy and recognition time. To increase the reliability of decoding, links with short spreading sequences can be introduced between individual bits of the audio payload. In this way, the integrity of the audio payload is improved. If a part of the audio payload is decoded incorrectly, then subsequent bits will be decoded by applying incorrect spreading sequences. Thus, the audio payload will not be decoded at the cost of decreasing the correlation value.

To ensure reliability, redundant coding can be applied to the audio payload in binary form. A checksum is added, e.g., CRC (cyclic redundancy check). After decoding, the checksum is verified. Audio payloads that do not pass the test are rejected.

### Simple Numerical Example 6

Suppose during encoding windows with a length of 4096 were used. During decoding windows with a length of 8192 are used, however not every frequency bin will be used, but only every second frequency bin. This improves recognition of an embedded audio payload because information from two windows is accumulated into one window.

Even better results can be achieved if during decoding windows of a length equal to three or four or x times the length of the encoding windows are used, and only every third, fourth, x frequency bin is used.

In some embodiments the following technique can be used instead of or in addition to the technique described above:

During decoding, the window size is chosen to be several times larger than the window size used during encoding. This results in a higher frequency resolution. It is clear that the frequency bins must be chosen so that the frequencies corresponding to them correspond to those that were chosen during coding. Due to the large window size, there is several times more information per frequency bin, since it is collected from several windows. Due to this, a greater correlation is achieved, and recognition is improved.

### BRIEF DESCRIPTION OF THE DRAWINGS

FIG. 1 shows a block schematic diagram of a system having a transient detector and an encoder according to an embodiment of the invention.

FIG. 2 shows a block schematic diagram of a decoder according to an embodiment of the invention.

FIG. 3 shows an embodiment of a scheme for constructing different spreading sequences.

FIG. 4 shows the structure of an example of audio payload.

### DETAILED DESCRIPTION OF THE INVENTION

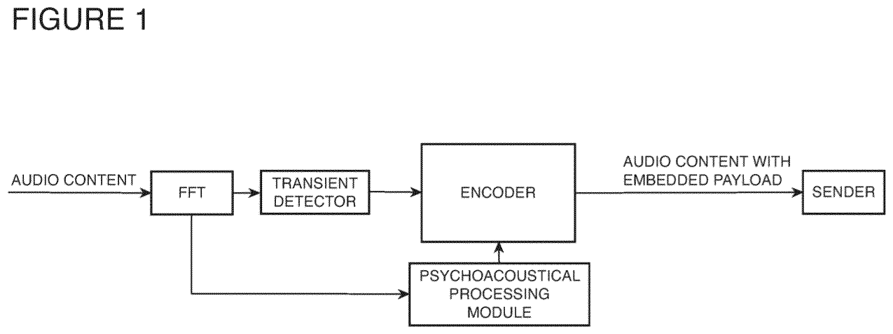

In FIG. 1, a system having a transient detector and an encoder according to the invention is shown. Although this is not shown, the encoder is, of course, provided with at least one electronic processing unit, electronic memory, a bus system and all other electronic components common for a computer. The transient detector, although a separate logical entity, can be provided as a configuration of the same hardware which is configured to act as the encoder, or a separate hardware can be provided.

The encoder is provided with the output of a module computing a Fast Fourier Transformation (FFT) which is provided with the audio content into which the audio payload is to be embedded as described above. The encoder provides the audio content with embedded audio payload to a sender which broadcasts this signal over the airwaves. As shown, an optional psychoacoustical processing module can be provided to preserve sound quality by enabling the encoder to encode the audio payload with a strength depending on the frequency range, e.g., using an absolute hearing threshold curve as described in ISO 226 to determine allowable strength of the audio payload depending on the frequency range.

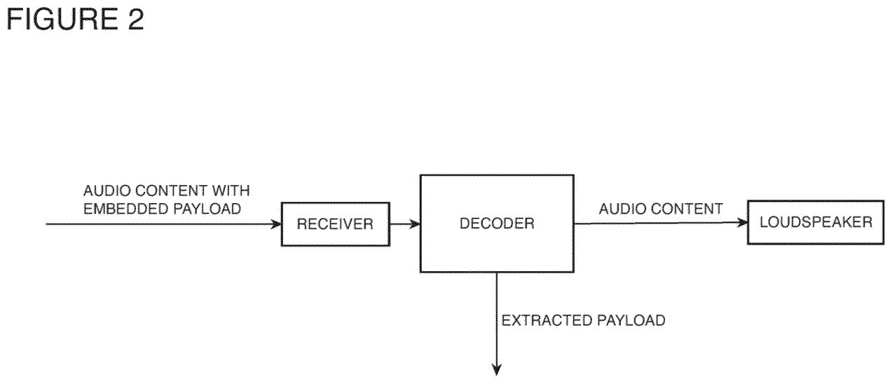

In FIG. 2, a decoder according to the invention is shown. Although this is not shown, the decoder is, of course, provided with at least one electronic processing unit, electronic memory, a bus system and all other electronic components common for a computer.

Audio content with embedded audio payload sent over the airwaves is received by a receiver and transmitted to the decoder which extracts the audio payload from the audio content as described below. The audio content itself can be transmitted, e.g., to a loudspeaker.

It should be noted that FIG. 1 shows different logical components as blocks. It is of course possible that each block corresponds to a physical piece of hardware. Alternatively, some of the different blocks or even all of them could be combined into one physical piece of hardware. The same holds true with respect to FIG. 2.

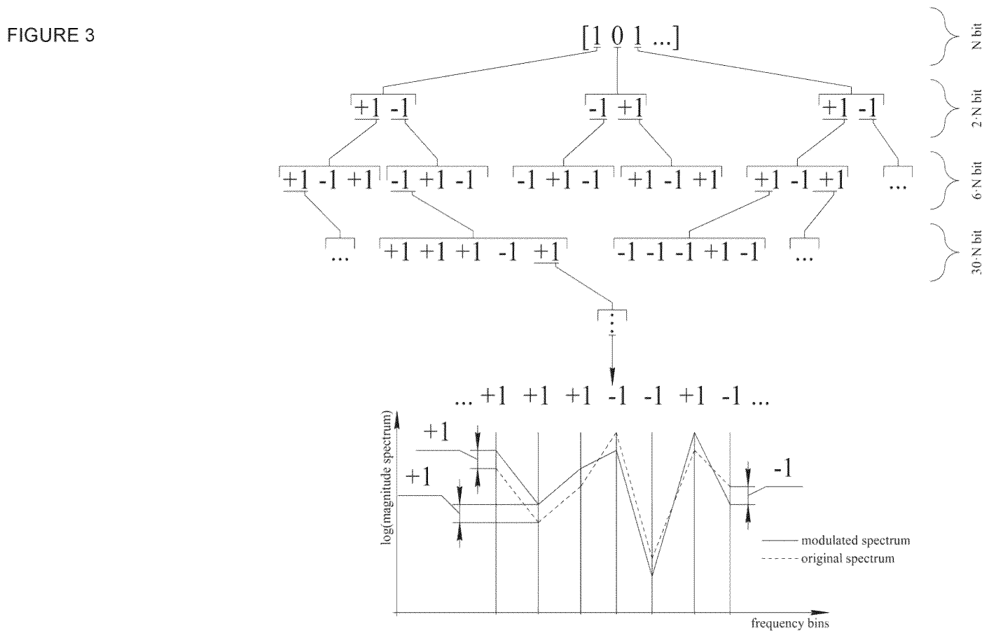

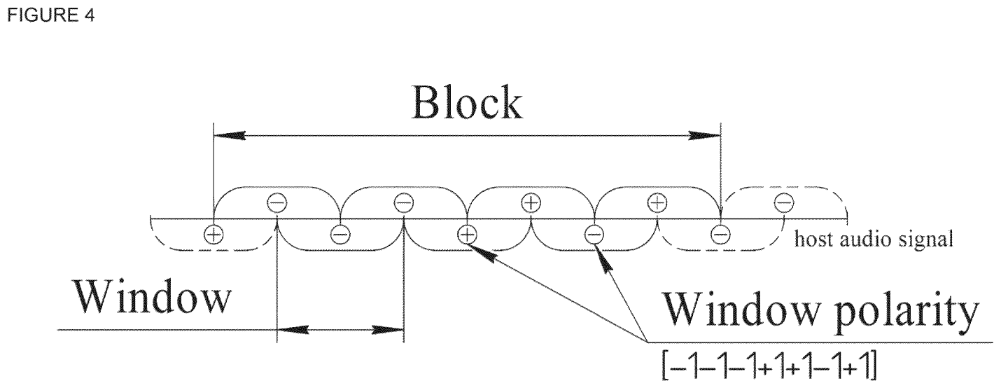

In the following, based on FIGS. 3 and 4, a preferred embodiment of a method for encoding at least one audio payload, in particular a watermark, in audio content is discussed, as well as a method for decoding at least one audio payload, in particular a watermark, from audio content.

The embodiment described herein uses multiple spreadings of the audio payload with short sequences which is found to result in more robust encoding than a single spreading using one long one spreading sequence as suggested in the art. That is, if the length (i.e., the one-dimensional size) of the audio payload is N, and the length of the first pn-sequence is L₁, then the length of the first spreading binary sequence will be equal to N·L₁.

In a preferred embodiment of the invention the bits with the value “1” should be spread with the direct sequence, and the bits with the value “0” with the same sequence, but with the opposite sign. The resulting sequence (with length N·L₁) is spread with a new pn-sequence of length L₂. Thus, a new spreading binary sequence of length N·L₁·L₂ is obtained. Continuing this process m times, a spreading binary sequence of length N·L₁·L₂· . . . · Lₘ is obtained. For stable detection of audio payload, m should be at least two or three.

As a result, the amplitude spectrum of the audio signal will be directly modulated by sequences of length Lₘ, which will be repeated N·L₁·L₂· . . . · Lₘ₋₁ times and differ only in signs (Lₘ and −1·Lₘ). To increase the resistance of the payload to various bandpass filters and equalizers, as well as cryptographic strength, Lₘ sequences are used to modulate the spectrum in a pseudo-random order. This order can be determined by a secret key for decoding the audio payload. Also, this key can be used to generate short pn-sequences.

The amplitude spectrum can be obtained, in particular, as a result of a short-term Fourier Transform with 50% overlap. An audio signal window is a fragment of a long spectrum to which a windowing transform into the frequency domain is applied. In this case, due to symmetry, the length of the spectrum L_{FFT} must satisfy the following condition: 0.5·L_{FFT}+1≥N·L₁·L₂· . . . · Lₘ (we further assume that L_{FFT} is always even, moreover, for fast Fourier transform, one should take L_{FFT}=2^{k}, k=1, 2 . . . ). In the case where the length of the spreading sequence is less than 0.5·L_{FFT}+1 the spreading sequence is adjusted to a work range of frequency bins as long as the inequality remains true. This occurs both at the beginning and at the end of the sequence to capture frequency bins that correspond to the 600 Hz to 13 kHz midrange, which typically forms the basis of a sound or musical composition.

After adjusting the spreading sequence to a length of 0.5·L_{FFT}+1, the amplitude spectrum is modulated.

Modulation can be carried out as follows. The amplitude spectrum is preferably converted to a semi-logarithmic scale. If the element is equal to “1”, then the amplitude of the spectrum increases (linear scale-multiplies) by a certain gain α—the strength of the audio payload. if the element is “−1”, then the amplitude of the spectrum is reduced by α. Thus, the window is the minimum length of the audio signal fragment, which completely contains the spreading sequence, and, consequently, the audio payload.

The decoding process can be similar to the encoding process.

Windows can be used such that a block in the decoder window is divided into windows. For each window, its amplitude spectrum is calculated.

The obtained spectra can be combined into one window. Window polarities can be determined by all possible permutations in the pn-sequence (e.g., Barker sequence) that was used for encoding.

The spectrum of the windows can be cropped to an expanding sequence of length N·L₁·L₂· . . . · Lₘ.

N·L₁·L₂· . . . · Lₘ₋₁ Next, the correlations between the spreading sequence and the spectrum can be found. The correlation results are combined into one new sequence of length.

After m iterations, a sequence of length N is obtained. Each value of the sequence is a correlation value. If in the received sequence the value is greater than zero it is 1, if it is less than zero it is 0.

1. A method for encoding at least one audio payload in audio content, the method comprising:
providing audio content, into which at least one audio payload is to be embedded, in the form of an amplitude spectrum in the frequency domain,
providing at least one audio payload in the form of a binary sequence,
applying a first spreading sequence to the binary sequence to obtain a first level spreading binary sequence,
applying at least one more spreading sequence different from the first spreading sequence to the first level spreading binary sequence to obtain at least one more spreading binary sequence of a higher level, and
using the at least one more spreading binary sequence of a higher level to modulate the amplitude spectrum of the audio content to embed the at least one audio payload into the audio content.

2. The method according to claim 1, wherein with respect to at least two different levels of spreading, the step of applying at least one spreading sequence of that level to the binary sequence of the previous level to obtain the at least one spreading binary sequence of a higher level, is done such that:
if a bit of the binary sequence of the previous level is of the first value, the bit is spread by the at least one spreading sequence of that level, and
if a bit of the binary sequence of the previous level is of the second value, the bit is spread by the negative of the at least one spreading sequence of that level.

3. The method according to claim 2, wherein the step of applying at least one more spreading sequence different from the first spreading sequence to the first level spreading binary sequence to obtain at least one more spreading binary sequence of a higher level includes at least:
providing a number of different spreading sequences,
applying a spreading sequence chosen from the number of spreading sequences to obtain a second level spreading binary sequence,
choosing a further spreading sequence from the number of spreading sequences and applying the further spreading sequence to obtain a third level spreading binary sequence,
repeating the previous step for a number of times, the number of times being equal to or larger than zero, until a highest-level spreading binary sequence is obtained,
and wherein the step of using the at least one more spreading binary sequence to modulate an amplitude spectrum of the audio content to embed the at least one audio payload into the audio content includes at least using the highest-level spreading binary sequence to modulate the amplitude spectrum of the audio content in the frequency domain to embed the at least one audio payload into the audio content.

4. The method according to claim 1, wherein the amplitude spectrum is fragmented into audio signal windows by applying a windowing transform into the frequency domain to the amplitude spectrum.

5. The method according to claim 4, wherein audio signal windows containing transients are encoded with less payload strength or are skipped.

6. The method according to claim 5, wherein several consecutive windows are combined into blocks, such that windows in one block contain the same binary sequence.

7. The method according to claim 6, wherein each window in a block is assigned a polarity and spectra of windows of one block are added in accordance with their polarity value.

8. The method according to claim 7, wherein the polarity of the windows is chosen according to the selected Barker sequence.

9. A method for decoding at least one audio payload from audio content, the method comprising:
providing audio content into which at least one audio payload was embedded in the form of an amplitude spectrum in the frequency domain,
obtaining the at least one spreading binary sequence that was used to modulate the amplitude spectrum of the audio content in the frequency domain for embedding the at least one audio payload into the audio content,
calculating at least one correlation coefficient between:
at least part of the amplitude spectrum of the audio content, and
the at least one spreading binary sequence, or its negative, and
depending on the sign of the at least one correlation coefficient determining whether an embedded bit of the at least one audio payload is of the first value or the second value thereby obtaining the value of the embedded bit of the embedded audio payload.

10. The method according to claim 9 wherein:
the step of obtaining the at least one spreading binary sequence that was used to modulate the amplitude spectrum of the audio content in the frequency domain for embedding the at least one audio payload into the audio content comprises obtaining all spreading binary sequences of different levels which were used to obtain the highest-level spreading binary sequence,
the step of calculating at least one correlation coefficient comprises calculating correlation coefficients between:
at least part of the amplitude spectrum of the audio content, and
the highest-level spreading binary sequence, or its negative thereby obtaining a sequence of highest-level correlation coefficients, and
for each lower level calculating at least one correlation coefficient between the sequence of correlation coefficients of the higher level and the spreading binary sequence of the lower level until the lowest level has been reached.

11. A method for decoding at least one audio payload from audio content, the method comprising:
obtaining the at least one more spreading binary sequence that was used to modulate the amplitude spectrum of the audio content for embedding the at least one audio payload into the audio content,
obtaining information about the number of windows used during encoding of the at least one audio payload,
using a decoder window to read a block of the audio content into which the at least one audio payload has been embedded,
dividing the block in the decoder window into a number of windows which is greater than the number of windows used during encoding of the at least one audio payload,
calculating for each window its amplitude spectrum,
combining the obtained amplitude spectra into one window, and
calculating at least one correlation between the at least one more spreading binary sequence and the combined amplitude spectra thereby obtaining the embedded audio payload.

12. The method according to claim 11, wherein:
there are provided at least three different spreading sequences that have been used to modulate the amplitude spectrum of the audio content to embed the at least one audio payload into the audio content,
for each of the provided spreading sequences, the correlation with the combined amplitude spectra is calculated,
the calculated correlations are combined into one new sequence of length N·L₁·L₂· . . . · Lₘ₋₁, and
iterating the process m times to obtain a sequence of length N.

13. The method according to claim 11, wherein, before the step of calculating at least one correlation, windows polarities are determined, preferably by all possible permutations in the spreading sequences that were used for encoding.

14. The method for detecting transients comprising checking each window of an audio payload before applying a method according to claim 11, wherein each window is split into fragments and a transient is discovered by discovering a change in a pre-determined property of the audio payload between adjacent fragments.

15. An encoder, a decoder or a transient detector configured, respectively, to encode at least one audio payload in audio content according to the method of claim 1.
